(19) United States
(12) Patent Application Publication
(10) Pub. No.: US 2026/0020097 A1
(43) Pub. Date: Jan. 15, 2026

(54) HYBRID MULTI ACCESS POINT COORDINATION SYSTEM

(71) Applicant: Cisco Technology, Inc., San Jose, CA (US)

(72) Inventors: Malcolm Muir Smith, Richardson, TX (US); Brian Donald Hart, Sunnyvale, CA (US); Binita Gupta, San Diego, CA (US)

(21) Appl. No.: 19/265,125

(22) Filed: Jul. 10, 2025

Related U.S. Application Data
(60) Provisional application No. 63/669,518, filed on Jul. 10, 2024.

(51) Int. Cl. H04W 76/20; H04W 72/12; H04W 72/54; H04W 74/0816

(52) U.S. Cl. CPC H04W 76/20; H04W 72/12; H04W 72/54; H04W 74/0816

(57) ABSTRACT

Aspects of the present disclosure are directed to a hybrid structure for switching between traffic-first mode and access point-first mode when coordinating traffic transmission among access points in a wireless network. In one aspect, a multi-access point coordination method includes determining, at an access point, whether a triggering condition exists for switching between a traffic-first mode and an access point-first mode or vice-versa when coordinating traffic transmission with other neighboring access points, wherein the triggering condition is associated with Start Time Protection Rules (STPRs) of the access point and the other neighboring access points; and switching from one of the traffic-first mode and the access point-first mode to another one of the traffic-first mode and the access point-first mode upon detecting the triggering condition.

### CROSS REFERENCE TO RELATED APPLICATIONS

This application claims priority to and benefit of U.S. Provisional Application No. 63/669,518 filed on Jul. 10, 2024, the entire content of which is incorporated herein by reference.

### TECHNICAL FIELD

The present disclosure relates to wireless communication standards, and in particular, to a hybrid structure for switching between traffic-first mode and access point-first mode when coordinating traffic transmission among access points in a wireless network.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and Wi-Fi 9, each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6/6E included enhanced orthogonal frequency-division multiple access (OFDMA) and target wake time (TWT) mechanisms and included greater frequency and improved overall spectral efficiency and power management and better performance in crowded areas. Wi-Fi 7 (802.11be) delivers speeds of up to 30 Gbps, utilizing multi-band operation, wider bandwidth, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc. Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new Wi-Fi generation brings improvements that address the growing demands of modern networks, including increased device density, higher data rates, lower latency, improved reliability and better overall network performance. These advancements play a crucial role in enabling emerging technologies, supporting the proliferation of smart devices, and transforming the way we connect and communicate in an increasingly interconnected world.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of an example wireless communication network according to some aspects of the present disclosure.

FIG. 2A illustrates an example of a single floor of building equipped with wireless communication according to some aspects of the present disclosure.

FIG. 2B depicts an illustrative schematic diagram for MLO between an AP MLD with affiliated logical entities and a non-AP MLD with affiliated logical entities according to some aspects of the present disclosure.

FIG. 3 illustrates an example architecture 300 in which multi-AP coordination technologies may be practiced according to some aspect of the present disclosure.

FIG. 4 illustrates an example method of MAPC using a hybrid traffic-first mode and access-point first mode, according to some aspects of the present disclosure.

FIG. 5 shows an example of computing system according to some aspects of the present disclosure.

### DETAILED DESCRIPTION

Various embodiments of the disclosure are discussed in detail below using examples. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### Overview

When it comes Multi Access Point Coordination (MAPC), APs can coordinate (schedule) traffic transmission with other APs in either a traffic-first mode or an access point-first mode. The present disclosure provides examples of a hybrid structure for switching between traffic-first mode and access point-first mode for MAPC based on various factors such as number of APs operating in traffic-first mode or access point-first mode, statistics associated with Start Time Protection Rule (STPR) of APs in the system, etc.

In one aspect, a multi-access point coordination method includes determining, at an access point, whether a triggering condition exists for switching between a traffic-first mode and an access point-first mode or vice-versa when coordinating traffic transmission with other neighboring access points, wherein the triggering condition is associated with Start Time Protection Rules (STPRs) of the access point and the other neighboring access points; and switching from one of the traffic-first mode and the access point-first mode to another one of the traffic-first mode and the access point-first mode upon detecting the triggering condition.

In another aspect, the triggering condition is one or more of a rate of the STPRs being greater than a threshold, a proportion of the STPRs being adjacent to one another relative to a threshold, and a number of the other neighboring access points following the access point-first mode.

In another aspect, the access point operates in the traffic-first mode and upon determining that the triggering condition exists, switches to the access point-first mode.

In another aspect, the access point operates in the access point-first mode and switches to the traffic-first mode upon determining that the triggering condition does not exist.

In another aspect, the access point operates in the access point-first mode and switches to the traffic-first mode based on dynamic conditions associated with one or more of a rate of STPRs, closeness of the STPRs, and a number of the other neighboring access points operating in the access point-first mode.

In another aspect, the method further includes determining, by the access point, whether to participate in the multi-access point coordination method based on a number of aggregated periodic flows that the access point has or anticipates to have for transmission.

In another aspect, the method further includes signaling, by the access point to at least one of the other neighboring access points, that the access point has switched from the traffic-first mode to the access point-first mode or vice-versa.

In another aspect, the access point signals that the access point has switched from the traffic-first mode to the access point-first mode or vice-versa, in one or more beacons, access point-to-access point management protocol, or via a Coordinated Restricted Target Wake Time (CRTWT) agreement.

In another aspect, the traffic-first mode is a mode in which scheduling of the traffic transmission is flow-centric whereby each traffic flow or a set of traffic flows has a corresponding Coordinated Restricted Target Wake Time (CRTWT) agreement.

In another aspect, the traffic-first mode is a mode in which scheduling of the traffic transmission is access point-centric whereby each access point has less than a threshold number of Coordinated Restricted Target Wake Time (CRTWT) agreements.

In another aspect, the traffic-first mode is a mode in which scheduling of the traffic transmission is one of Target Beacon Transmission Time (TBTT) centric or round-number centric.

In another aspect, the access point has at least one a priori agreement with one or more of the other neighboring access points to operate in the traffic-first mode or the access point-first mode.

In one aspect, an access point includes one or more memories having computer-readable instructions stored therein, and one or more processors. The one or more processors are configured to execute the computer-readable instructions to participate in a multi-access point coordination process, by determining whether a triggering condition exists for switching between a traffic-first mode and an access point-first mode or vice-versa when coordinating traffic transmission with other neighboring access points, wherein the triggering condition is associated with Start Time Protection Rules (STPRs) of the access point and the other neighboring access points; and switching from one of the traffic-first mode and the access point-first mode to another one of the traffic-first mode and the access point-first mode upon detecting the triggering condition.

In one aspect, one or more non-transitory computer-readable media including computer-readable instructions, which when executed by one or more processors of an access point, cause the access point to participate in a multi-access point coordination process, by determining whether a triggering condition exists for switching between a traffic-first mode and an access point-first mode or vice-versa when coordinating traffic transmission with other neighboring access points, wherein the triggering condition is associated with Start Time Protection Rules (STPRs) of the access point and the other neighboring access points; and switching from one of the traffic-first mode and the access point-first mode to another one of the traffic-first mode and the access point-first mode upon detecting the triggering condition.

### EXAMPLE EMBODIMENTS

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency call for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11 is coined as Wi-Fi 8. Wi-Fi 8 will attempt to further improve reliability and minimize latency to meet the ever-growing demand for the Internet of Things (IoT), high resolution video streaming, low-latency wireless services, wireless Time Sensitive Networking (TSN) etc.

Multiple Access Point (AP) coordination and transmission in Wi-Fi refers to the management of multiple access points in a wireless network to avoid interference and ensure efficient communication between the STA devices and the network. When multiple access points are deployed in a network—for instance in buildings and office complexes—they operate on the same radio frequency, which can cause interference and degrade the network performance. To mitigate this issue, access points can be configured to coordinate their transmissions and avoid overlapping channels.

Wi-Fi 8 supports MAPC technologies including Coordinated Time Division Multiple Access (C-TDMA), coordinated Spatial Re-Use (C-SR), Multi-AP Coordination Service Period (MAPC-SP), Coordinated-Restricted Target Wake Time (C-RTWT). Coordinated Orthogonal Frequency Division Multiple Access (C-OFDMA), Coordinated Beamforming (C-BF), Joint Transmission (JT), etc., to collaborate and coordinate resource allocation for optimized performance. Among different MAPC technologies, C-RTWT and C-TDMA have been proposed to be combined for periodic traffic, with known periodic flows exchanged between APs. According to this combination, C-RTWT is used to force the STPR onto adjacent BSSs such that at the start of each C-RTWT SP, one AP can transmit at a known time with low latency/low collision probability.

Once the AP becomes the TXOP holder then either (1) the AP performs AP-to-AP (AP2AP) polling to establish how much Downlink (DL)+Uplink (UL) traffic is buffered at APs (and STAs) in other BSSs and optionally what priority and delay/expiry imminence the AP has (i.e., AQRP) (both for the APs own BSS and other BSSs); or (2) the AP uses prior information about periodic traffic in AP's own BSS and other BSSs to select other APs. This coordination is then followed by performing C-TDMA to grant time to the AP and neighboring APs according to the amount, priority and or delay/expiry imminence of their buffered traffic.

Currently, the coordination between the APs for grating time to each other is either traffic based (traffic-first mode) or access point based (access point-first mode). Details of these two modes are described below.

Aspects of the present disclosure are directed to providing hybrid structure for switching between traffic-first mode and access point-first mode for MAPC based on various factors such as number of APs operating in traffic-first mode or access point-first mode, statistics associated with Start Time Protection Rule (STPR) of APs in the system, etc.

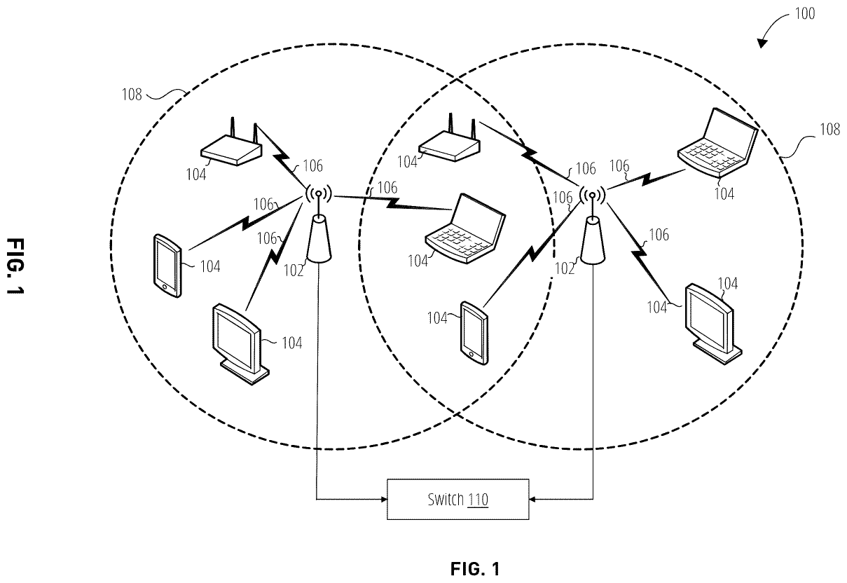

FIG. 1 illustrates a block diagram of an example wireless communication network according to some aspects of the present disclosure.

According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein.

Wireless communication network 100 may include numerous wireless communication devices such as an AP, which can be one or more of a non-MLD AP, an AP affiliated with an AP MLD, and/or an AP MLD. In the examples presented herein, the AP can exclude an upper UMAC. Therefore, the AP can include the lower UMAC, LMAC, and/or PHY. Additionally, the WLAN can include one or more of STAs 104, which can be one or more of a non-MLD STA, a STA affiliated with a non-AP MLD, and/or a non-AP MLD. As illustrated, wireless communication network 100 also may include multiple APs such as APs 102 (may also be referred to as simply AP). APs 102 can be coupled to one another through a switch 110. While APs 102 are shown as being coupled to one another through switch 110, wireless communication network 100 can provide another device that allows the coupling of multiple APs. In another example, switch 110 can be a network controller configured to coordinate and manage operations of different APs such as APs 102.

Each of STAs 104 also may be referred to as a mobile station (MS), a mobile device, a mobile handset, a wireless handset, an access terminal (AT), a user equipment (UE), a subscriber station (SS), client, or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STAs 104 can be referred to as clients and/or client devices.

Any one of APs 102 and an associated set of STAs (e.g., STAs 104) may be referred to as a basic service set (BSS), which is managed by a respective AP of APs 102. FIG. 1 additionally shows an example coverage area 108 of the each of APs 102, which may represent a basic service area (BSA) of wireless communication network 100. As illustrated, three of STAs 104 are within the BSA of each of APs 102. The BSS may be identified to users by a service set identifier (SSID), where the BSS might be one of many in the SSID. The BSS may be identified to other devices by a unique (or substantially unique) basic service set identifier (BSSID). One or more of APs 102 periodically broadcasts beacon frames (“beacons”) including the BSSID to enable STAs 104 within a wireless range of one or more of APs 102 to “associate” or re-associate with APs 102 to establish a respective communication link of communication links 106 (hereinafter also referred to as a “Wi-Fi link”), or to maintain communication links 106, with APs 102. For example, the beacons may include an identification of a primary channel used by respective AP of APs 102 as well as a timing synchronization function for establishing or maintaining timing synchronization with APs 102. APs 102 may provide communication links 106 to STAs 104 and therefore access to external networks. While the example has been described in regard to APs 102 and STAs 104, the present disclosure extends such that an AP may provide access to external networks to various STAs in a WLAN via communication links 106.

To establish communication links 106 with any one of APs 102, each of STAs 104 is configured to perform passive or active scanning operations (“scans”) on frequency channels in one or more frequency bands (for example, the 2.4 GHz, 5 GHz, 6 GHz, or 60 GHz bands). To perform passive scanning, STAs 104 listen for beacons, which are transmitted by a respective AP of APs 102 at or near a periodic time referred to as the target beacon transmission time (TBTT) (measured in time units (TUs) where one TU may be equal to 1024 microseconds (μs)).

To perform active scanning, STAs 104 generate and sequentially transmits probe requests on each channel to be scanned and listens for probe responses from APs 102. STAs 104 may be configured to identify or select an AP and thence a selected AP of APs 102 with which to associate based on the scanning information obtained through the passive or active scans, and to perform authentication and association operations to establish the communication links 106 with the selected AP of APs 102. The selected AP of APs 102 assigns an association identifier (AID) to STAs 104 at the culmination of the association operations, which selected AP of APs 102 uses to improve the efficiency of certain signaling to the STAs 104.

The present disclosure modified the WLAN radio and baseband protocols for the PHY and medium access controller (MAC) layers. APs 102 and STAs 104 transmit and receive wireless communications (hereinafter also referred to as “Wi-Fi communications”) to and from one another in the form of PHY protocol data units (PPDUs). APs 102 and STAs 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

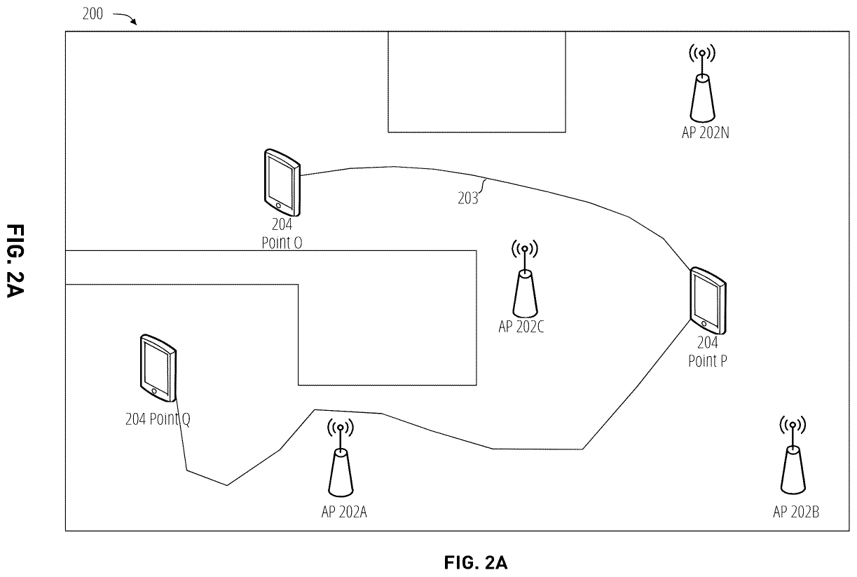

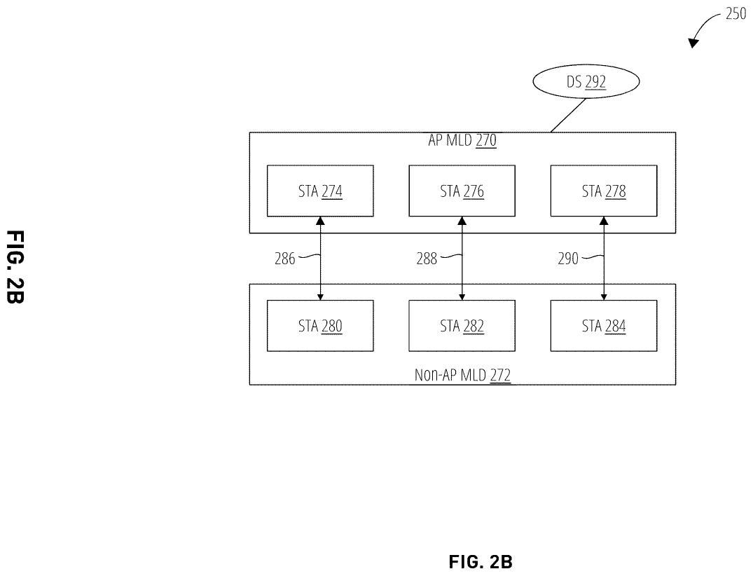

FIG. 2A illustrates an example of a single floor of building equipped with wireless communication according to some aspects of the present disclosure.

While only a single floor 200 is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more APs. As illustrated, the single floor 200 includes AP 202A, AP 202B, AP 202C, and AP 202N. Each of the AP 202A, AP 202B, AP 202C, and/or AP 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP of AP 202A, AP 202B, AP 202C, and AP 202N may substantially overlap with the coverage of another AP of the AP 202A, AP 202B, AP 202C, and AP 202N.

As illustrated by line 203, STA 204 can move from point O to point P to point Q. When a STA 204 is moving around on a given floor, one or more of AP 202A, AP 202B, AP 202C, and AP 202N can be considered to be nearest to STA 204. Nearest as used in relation to AP 202A, AP 202B, AP 202C, AP 202N and STA 204 can include being physically nearest (for example, a Euclidean distance on the floor) and/or pathloss-nearest (for example, having the lowest wireless attenuation (pathloss) between a subset of APs, among all the APs, and the STA). Additionally, the pathloss-nearest approach can be used to reduce the likelihood of connection between an AP on a floor above or below STA 204. The location of the AP on the floor above or below might be closer in a Euclidean sense, but also not be a desirable AP for the connection of the device or station due to the floor location and/or possible signal interruption. The location of the AP on the floor above or below might be closer in a straight line and/or Euclidean sense, but also not be a desirable AP for the connection of the device or station due to the floor location and/or possible signal interruption. Additionally, the coverage of one or more APs can at least partially overlap with the coverage of one or more other APs. The present disclosure provides for selecting the AP and/or providing a communication pathway from one or more STA through one or more APs.

FIG. 2B depicts an illustrative schematic diagram for MLO between an AP MLD with affiliated logical entities and a non-AP MLD with affiliated logical entities according to some aspects of the present disclosure.

Referring to FIG. 2B, schematic diagram 250 may include two multi-link logical entities AP MLD 270 and Non-AP MLD 272. AP MLD 270 may include physical and/or logically affiliated AP such as AP 274, AP 276, and AP 278 operating in different channels and typically different frequency bands (e.g., 2.4 GHz, 5 GHz, and 6 GHz). AP 274, AP 276, and AP 278 may be the same as or similar to any one of the APs described above. Non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) such as DS 292, which is a system used to interconnect a set of BSSs to create an extended service set (ESS).

It should be understood that although the example shows three logical entities within the AP MLD and the three logical entities within the non-AP MLD, this is merely for illustration purposes and that other numbers of logical entities within each of the AP MLD and Non-AP MLD may be envisioned. The example Wi-Fi systems and MLO described above with reference to FIGS. 1 and 2A-2B provide examples of simplified and example systems of the present disclosure.

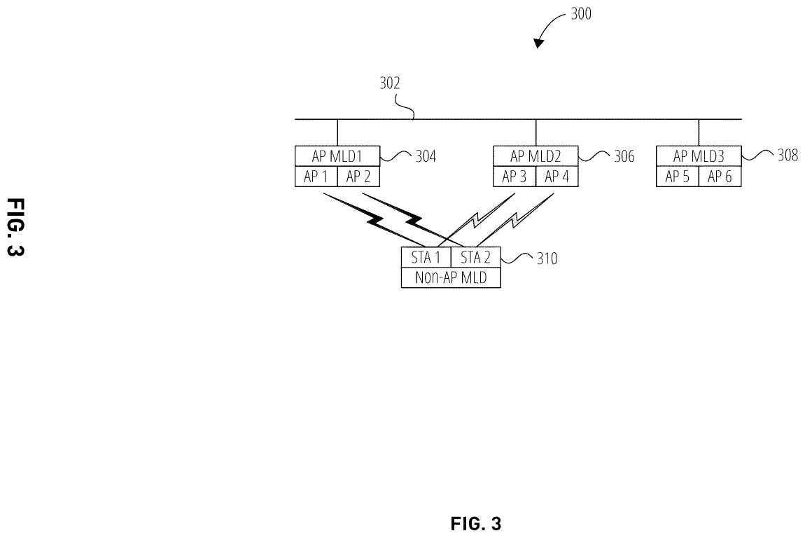

FIG. 3 illustrates an example architecture 300 in which multi-AP coordination technologies may be practiced according to some aspect of the present disclosure.

The architecture 300 includes a DS 302 (may be the same as the DS 292) that is a logically connected entity that includes AP MLD1 304, AP MLD2 306, and AP MLD3 308, all of which can form an ESS (e.g., all AP MLDs which are part of a campus ESS network). Architecture 300 also shows a non-AP MLD 310 that may be connected to AP MLD1 304.

AP MLD1 304 may include one or more APs such as AP1 and AP2. AP1 and AP2 may be different physical APs (or AP interfaces) co-located in AP MLD1 304. Similarly, AP MLD2 306 may include one or more APs such as AP3 and AP4. AP3 and AP4 may be different physical APs (or AP interfaces) co-located in AP MLD2 306. Similarly, AP MLD3 308 may include one or more APs such as AP5 and AP6. AP5 and AP6 may be different physical APs (or AP interfaces) co-located in AP MLD3 308. The number of AP MLDs and/or the number of respective APs of each AP MLD is not limited to the example numbers shown in FIG. 2B and may include more or less.

In one example, AP MLD1 304, AP MLD2 306, and AP MLD3 308 may be located in different geographical locations (e.g., different rooms of the same building, different floors of the same building, different buildings of the same campus or area, etc.).

The non-AP MLD 310 may be any known or to be developed device capable of establishing one or more wireless communication links with one or more of AP MLD1 304, AP MLD2 306, and/or AP MLD3 308. As a non-limiting example, non-AP MLD 310 may be a mobile device having two wireless interfaces, each of which may correspond to one of STA 1 or STA 2. In one example, each one of STA 1 and STA 2 may operate on a different link (e.g., 5 GHz for STA 1 and 6 GHz for STA 2). The number of non-AP MLDs and/or STAs associated with each is not limited to that shown in FIG. 3 and may be more or less.

As shown in FIG. 3, the non-AP MLD 310 is associated with the architecture 300 with multiple links set up with the AP MLD1 304 (for example, 2.4 GHz link with the AP1 for the STA 1 and 5 GHz link with the AP2 for the STA 2). For one of the links (for example, 2.4 GHz), the AP MLD1 304 may detect a weak RSSI. As a result, AP MLD1 304 determines a specific roaming target AP3 of AP MLD2 306 for that link to Switch too. Similarly, the same process may be performed for the other link (for example, the 5 GHz) to Switch to a link with STA 4 on the AP MLD2 205.

As noted above, in a combined use of MAPC and C-TDMA, MAPC is used by APs either in the same administrative domain or across administrative domains to coordinate network resource utilization and airtime to schedule their respective traffic transmissions. Basically, APs coordinate their behavior to improve overall network efficiency, reduce interference, and deliver higher throughput and lower latency.

As far as coordinating their respective traffic transmissions is concerned, APs can operate in one of a traffic-first mode (traffic centric mode) and an access point-first mode (AP centric mode).

Traffic-first mode is a MAPC mechanism where the coordination decisions among APs are primarily driven by actual traffic demands rather than predefined schedules or rules. In this mode, each AP has different Coordinated Restricted Target Wake Time (CRTWT) agreement with one or more other APs (neighboring APs) for any given type or group of network traffic flows (flows). Flows can be grouped as being the same or similar based on a number of different parameters including, but not limited to, Service Interval (SI), priority, Service Start Time (SST), etc. Each CRTWT may have its corresponding sequence of STPRs. For example, one CRTWT may provide a Service Period (SP) every 20.01 msec and another CRTWT may provide an SP every 16.65 msec, etc.

Access point-first mode is a MPAC mechanism where coordination is driven by a predefined, AP-controlled schedule rather than dynamic traffic demands. In this mode, each AP has one (or a small number of) CRTWT agreements, and the collection of APs has approximately regular and well-spaced STPRs.

In some examples, access point-first mode may be suited to cases with some aggregated periodic flows on every AP and a high number of aggregated periodic flows in total, since it generally avoids having very short TXOPs; but the TXOP starts are not well aligned with the traffic burst starts, so latency can be higher.

Two non-limiting examples of access point-first mode is Target Beacon Transmission Time (TBTT)-centric scheduling and round-number-centric scheduling.

TTBT-centric scheduling is where a Beacon Interval (BI) is divided into M (an integer equal to or greater than 1) SPs. Here, given up to N (an integer equal to or greater than 1) overlapping BSSs, each AP gets 1 SP every N of these SPs. This means that a given SI is given by:

SI=BI*N/M TUs
where TU stands for Time Unit and the time between start of adjacent SPs (and max SP duration) is BI*N/M TUs. For example, if BI=100 TU, and M=[2 5 10 20 50 100 200 500 1000] SPs, time between the start of adjacent SPs (and the max SP duration) would be[50 20 10 5 2 1 0.5 0.2 0.1] TUs respectively.

Round-number-centric scheduling is where each RTWT uses the same SI which is chosen to be suitable across a range of use cases. For example, a new SP starts every 2 msec, and each AP gets a SP every 12 msec.

In some examples, traffic-first mode may be suited for scenarios where a given AP does not have too many periodic flows or has no flows at all. In these instances, traffic-first mode can minimize burst latencies, but conversely can lead to short Transmit opportunities (TXOPs) due to nearby STPRs from the CRTWT agreements.

In some examples, access point-first mode may be suited to cases with some aggregated periodic flows on every AP and a high number of aggregated periodic flows in total, since it generally avoids having very short TXOPs; but the TXOP starts are not well aligned with the traffic burst starts, so latency can be higher.

Due to advantages and disadvantages of both traffic-first mode and access point-first mode, the present disclosure proposed a hybrid structure that allows for both modes of coordination in order to maximize the advantages of each while reducing the disadvantages thereof.

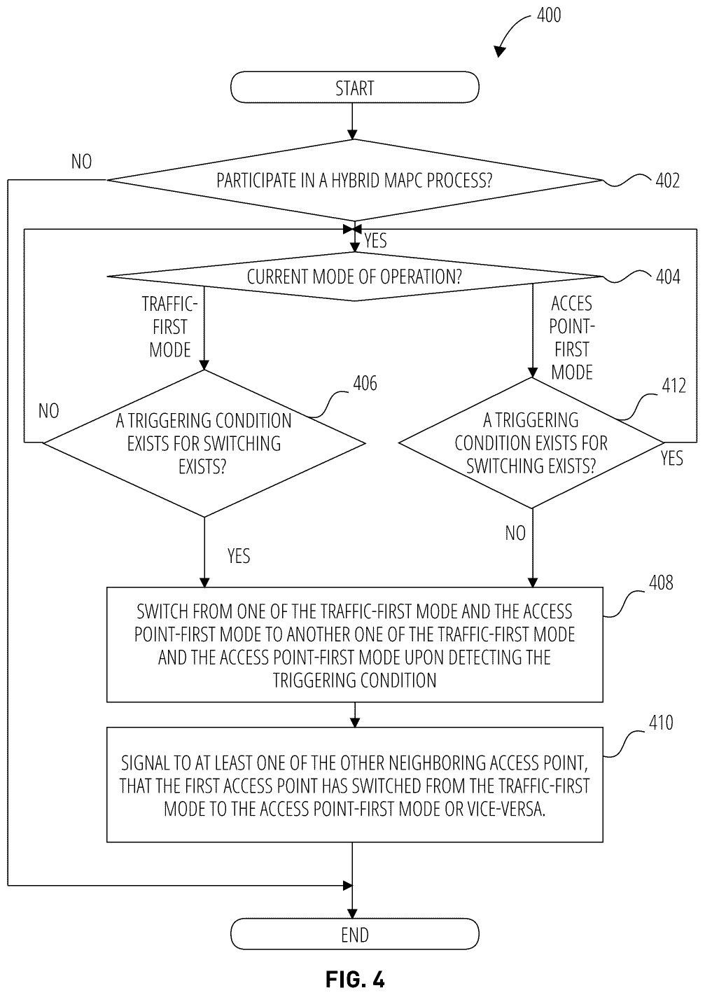

FIG. 4 illustrates an example method of MAPC using a hybrid traffic-first mode and access-point first mode, according to some aspects of the present disclosure.

Steps of FIG. 4 may be performed by any given access point (e.g., any one of APs 102, AP MLD 304, AP MLD 306, AP MLD 308, etc.) and/or alternatively by a centralized controller (e.g., switch 110 functioning as an overlay control components for managing operations of APs 102).

Example process 400 may start at step 402 where an access point determines if access point wants to participate in a hybrid MAPC process (MAPC system) with other neighboring access points. For example, the access point may be without any aggregated periodic flows (and optionally does not expect any to start soon). In this instance, the access point determines not to participate in the hybrid MAPC.

In another example, the access point may be without any aggregated periodic flows but anticipates flows and one or more or a majority of access point's neighboring access points have enough aggregated periodic flows that follow an access point-first mode for coordination. In this instance, the access point participates in the hybrid MAPC and creates a CRTWT agreement. This pre-traffic CRTWT creation results in less AP2AP disruption when and if an aggregated periodic flow starts on the access point.

If the access point determines not to participate in a hybrid MAPC process (No at step 416), process 400 ends.

However, if the access point determines to participate in the hybrid MAPC process (Yes at step 416), then at step 404, a determination is made as to whether the access point currently operates in a traffic-first mode or an access point-first mode.

If the access point currently operates in the traffic-first mode, then at step 406, the access point determine whether a triggering condition exists for switching between a traffic-first mode and an access point-first mode or vice-versa when coordinating traffic transmission with other neighboring access points.

In one example, the triggering condition can be one or more of a rate of STPRs, closeness of STPRs (e.g., a rate of closeness of STPRs), a proportion or number of neighboring access points operating in access point-first mode, number of flows, and/or number of flows with different SIs.

In one example, when a rate of STPRs is considered, the access point may determine whether a number of STPRs for the access point and/or the neighboring access points exceeds a given rate threshold (e.g., one STPR per 2 msec). The threshold may be a configurable parameter determined based on experiments and/or empirical studies.

In another example, when the closeness of STPRs is considered, the access point may determine the number or percentage of STPRs that are closer to each other than a configurable threshold. This percentage can be constant (e.g., 10% at any given time) or may be time-based (e.g., 10% every 100 milliseconds, every 1 second, etc.).

In another example, when the proportion of neighboring access points operating in access point-first mode is considered, the access point may determine if more or less than a configurable threshold of the neighboring access points are operating in the access point-first mode or not.

In another example, when the number of flows or a number of flows with different SIs is considered, the access point may determine if more than a configurable threshold of flows exists and/or whether more than a configurable threshold of flows with different SIs exist.

The access point may consider and determine that the triggering condition exists if any one or more of the one or more example triggering conditions described above is valid (e.g., the rate of STPRs is greater than a threshold, more than a threshold number of STPRs are close together in time, more than a threshold number of neighboring APs operate based on the access point-first mode, and/or more than a threshold number of flows or flows with different SIs exist).

In one example, if the triggering condition does not exist (No at step 406), then process 400 revers back to step 404.

However, if the access point determines that the condition exists (Yes at step 406), then at step 408, the access point switches from traffic-first mode to access point-first mode. The switching process may be performed according to any known or to be developed mechanism and technique compliant with the standards.

Once the access point has made the switch, at step 410, the access point may signal the switching from traffic-first mode to access point-first mode to one or more of the neighboring access points. This signaling can be performed using Beacons, AP2AP Management Protocol, and/or implicitly via the access point changing its CRTWT agreements from one per periodic flow to one (or a small number) per access point. In one example, this change can be for one flow or for a number of flows having the same SI with an offset SST as nearby access points or vice-versa.

Referring back to step 404, if the access point is currently operating in access point-first mode, then at step 412, the access point determines if any one or more of the triggering conditions as described above are valid.

If any one or more of the conditions is/are valid (Yes at step 412), process 400 reverts back to step 404.

However, if none of the triggering conditions is valid (No at step 412), process 400 proceeds to step 408, where the access point switches from access point-first mode to traffic-first mode. Thereafter, process 400 proceeds to step 410, which may be performed as described above.

In one example, at step 412, the access point may utilize different thresholds to determine if one or more triggering conditions exist, compared to the configurable thresholds used in making the same determination at step 406, in order to determine not to switch modes. The reason for doing so may be to minimize thrashing between modalities (i.e., hysteresis).

Example process 400 is described as being performed by anyone (individual) access point operating in a given wireless network. In another example, such wireless network (e.g., WiFi-8) network may have a controller (e.g., switch 110) and process 400 may be performed by such controller.

In another example, the access point and the neighboring access points may belong to two different administrative domains (e.g., two different companies occupying adjacent offices or floors in a building). In such scenario, individual access points within the same administrative domain may perform process 400 while controllers of the two administrative domains may perform a similar process at the controller level.

In another example, prior to initiation of process 400, any two or more access points (e.g., AP A and AP B) may have apriori agreement to operate in a traffic-first mode or an access point-first mode. Thereafter, upon each or at least one such access point (e.g., AP A) performing the process 400 and determining to switch modes, all access points that initially agreed on a given mode (e.g., AP B) may also make the switch to the same mode (e.g., AP B switching to the same mode as AP A without performing the process 400).

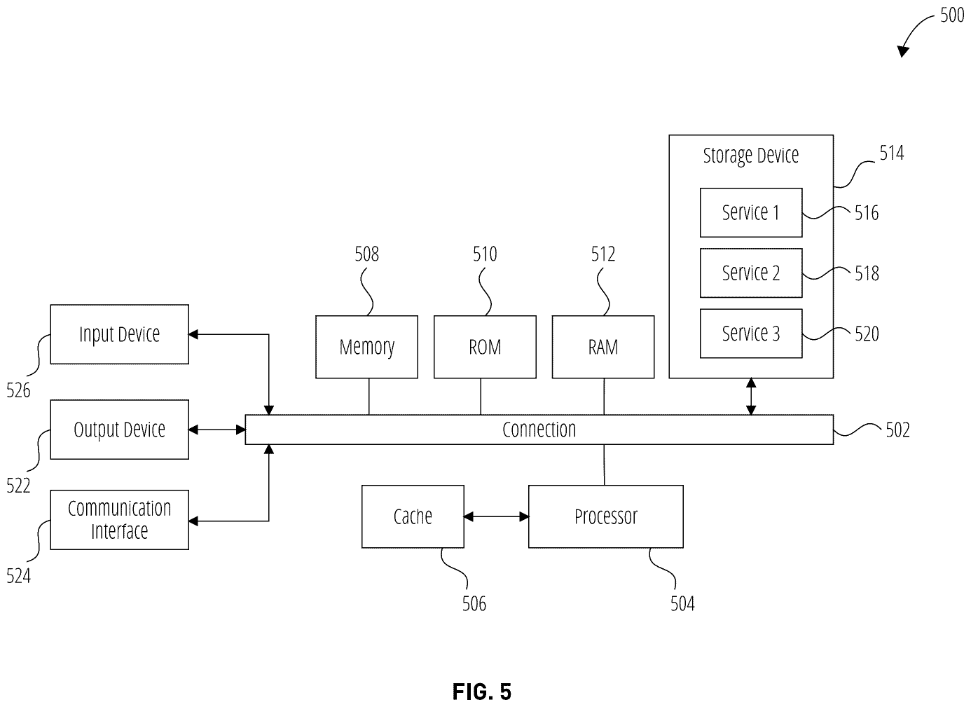

FIG. 5 shows an example of computing system according to some aspects of the present disclosure.

For example, computing system 500 may be any component of wireless communication network 100 and settings shown in FIGS. 1-3 such as APs 102, switch 110 (controller), STAs 104, APs and devices shown in FIGS. 2A and 2B, AP MLD 1 304, AP MLD 2 306, AP MLD 3 308, non-AP MLD 310, and/or any component of thereof. Various components of computing system 500 may be in communication with each other using connection 502. Connection 502 can be a physical connection via a bus, or a direct connection into processor 504, such as in a chipset architecture. Connection 502 can also be a virtual connection, networked connection, or logical connection.

In some examples, computing system 500 is a distributed system in which the functions described in this disclosure can be distributed within a datacenter, multiple data centers, a peer network, etc. In some embodiments, one or more of the described system components represents many such components, each performing some or all of the function for which the component is described. In some embodiments, the components can be physical or virtual devices.

Example computing system 500 includes at least one processing unit (CPU or processor) such as processor 504 and connection 502 that couples various system components including system memory 508, such as read-only memory (ROM) such as ROM 510 and random access memory (RAM) such as RAM 512 to processor 504. Computing system 500 can include a cache of high-speed memory 506 connected directly with, in close proximity to, or integrated as part of processor 504.

Processor 504 can include any general purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program or a collection of programs that carry out a specific function. In some embodiments, a service can be considered a server. The memory can be a non-transitory computer-readable medium.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A multi-access point coordination method comprising:
determining, at an access point, whether a triggering condition exists for switching between a traffic-first mode and an access point-first mode or vice-versa when coordinating traffic transmission with other neighboring access points, wherein the triggering condition is associated with Start Time Protection Rules (STPRs) of the access point and the other neighboring access points; and
switching from one of the traffic-first mode and the access point-first mode to another one of the traffic-first mode and the access point-first mode upon detecting the triggering condition.

2. The multi-access point coordination method of claim 1, wherein triggering condition is one or more of:
a rate of the STPRs being greater than a threshold,
a proportion of the STPRs being adjacent to one another relative to a threshold, and
a number of the other neighboring access points following the access point-first mode.

3. The multi-access point coordination method of claim 1, wherein the access point operates in the traffic-first mode and upon determining that the triggering condition exists, switches to the access point-first mode.

4. The multi-access point coordination method of claim 1, wherein the access point operates in the access point-first mode and switches to the traffic-first mode upon determining that the triggering condition does not exist.

5. The multi-access point coordination method of claim 1, wherein the access point operates in the access point-first mode and switches to the traffic-first mode based on dynamic conditions associated with one or more of a rate of STPRs, closeness of the STPRs, and a number of the other neighboring access points operating in the access point-first mode.

6. The multi-access point coordination method of claim 1, further comprising:
determining, by the access point, whether to participate in the multi-access point coordination method based on a number of aggregated periodic flows that the access point has or anticipates to have for transmission.

7. The multi-access point coordination method of claim 1, further comprising:
signaling, by the access point to at least one of the other neighboring access points, that the access point has switched from the traffic-first mode to the access point-first mode or vice-versa.

8. The multi-access point coordination method of claim 7, wherein the access point signals that the access point has switched from the traffic-first mode to the access point-first mode or vice-versa, in one or more beacons, access point-to-access point management protocol, or via a Coordinated Restricted Target Wake Time (CRTWT) agreement.

9. The multi-access point coordination method of claim 1, wherein the traffic-first mode is a mode in which scheduling of the traffic transmission is flow-centric whereby each traffic flow or a set of traffic flows has a corresponding Coordinated Restricted Target Wake Time (CRTWT) agreement.

10. The multi-access point coordination method of claim 1, wherein the traffic-first mode is a mode in which scheduling of the traffic transmission is access point-centric whereby each access point has less than a threshold number of Coordinated Restricted Target Wake Time (CRTWT) agreements.

11. The multi-access point coordination method of claim 1, wherein the traffic-first mode is a mode in which scheduling of the traffic transmission is one of Target Beacon Transmission Time (TBTT) centric or round-number centric.

12. The multi-access point coordination method of claim 1, wherein the access point has at least one a priori agreement with one or more of the other neighboring access points to operate in the traffic-first mode or the access point-first mode.

13. An access point comprising:
one or more memories having computer-readable instructions stored therein; and
one or more processors configured to execute the computer-readable instructions to participate in a multi-access point coordination process, by:
determining whether a triggering condition exists for switching between a traffic-first mode and an access point-first mode or vice-versa when coordinating traffic transmission with other neighboring access points, wherein the triggering condition is associated with Start Time Protection Rules (STPRs) of the access point and the other neighboring access points; and
switching from one of the traffic-first mode and the access point-first mode to another one of the traffic-first mode and the access point-first mode upon detecting the triggering condition.

14. The access point of claim 13, wherein triggering condition is one or more of:
a rate of the STPRs being greater than a threshold,
a proportion of the STPRs being adjacent to one another relative to a threshold, and
a number of the other neighboring access points following the access point-first mode.

15. The access point of claim 13, wherein the access point operates in the traffic-first mode and upon determining that the triggering condition exists, switches to the access point-first mode.

16. The access point of claim 13, wherein the access point operates in the access point-first mode and switches to the traffic-first mode upon determining that the triggering condition does not exist.

17. The access point of claim 13, wherein the one or more processors are further configured to execute the computer-readable instructions to determine whether to participate in the multi-access point coordination process based on a number of aggregated periodic flows that the access point has or anticipates to have for transmission.

18. The access point of claim 13, wherein the one or more processors are further configured to execute the computer-readable instructions to signal to at least one of the other neighboring access points, that the access point has switched from the traffic-first mode to the access point-first mode or vice-versa.

19. The access point of claim 13, wherein,
the traffic-first mode is a mode in which scheduling of the traffic transmission is flow-centric whereby each traffic flow or a set of traffic flows has a corresponding Coordinated Restricted Target Wake Time (CRTWT) agreement, and
the traffic-first mode is a mode in which scheduling of the traffic transmission is access point-centric whereby each access point has less than a threshold number of Coordinated Restricted Target Wake Time (CRTWT) agreements.

20. The access point of claim 13, wherein the access point has at least one a priori agreement with one or more of the other neighboring access points to operate in the traffic-first mode or the access point-first mode.
